(19) United States
(12) Patent Application Publication
(10) Pub. No.: US 2006/0252841 A1
(43) Pub. Date: Nov. 9, 2006

(54) Method of producing a polymer for making proton conductive membranes

(76) Inventors: Kai Jakoby, Dusseldorf (DE); Suzana Nunes Pereira, Geesthacht (DE); Klaus-Victor Peinemann, Geesthacht (DE)

Correspondence Address: KLAUS J. BACH, 4407 TWIN OAKS DRIVE, MURRYSVILLE, PA, 15668, US

(21) Appl. No.: 11/486,778

(22) Filed: Jul. 15, 2006

Related U.S. Application Data
(62) Division of application No. 10/303,071, filed on Nov. 23, 2002, now Pat. No. 7,101,637.

(30) Foreign Application Priority Data
Sep. 28, 2001 (DE) 101 48 131.4

(51) Int. Cl. C08J 5/22; C08G 75/00; C08G 79/02

(52) U.S. Cl. 521/27; 528/398; 528/373

(57) ABSTRACT

In a method of producing a polymer for making proton conductive membranes on the basis of a base polymer other than a vinyl polymer said base polymer is a) bromated or iodized, b) the bromated or iodized polymer is reacted with at least one of phosphonic acid esters and phosphoric acid esters in the presence of a transition metal catalyst whereby a reaction polymer is formed, c) the reaction polymer of step b is hydrolyzed, and d) from the hydrolyzed polymer of step c) a polymer film is produced.

This is a divisional application of pending patent application Ser. No. 10/303,071 filed 11/23/02.

### BACKGROUND OF THE INVENTION

The invention relates to a method of producing a polymer for making a proton conductive membrane for electrochemical applications and to a polymer for the manufacture of the membrane.

Fuel cells are considered to be promising low-emission alternatives for conventional energy generation apparatus. For mobile applications, the polymer electrolyte membrane fuel cell (PEM) is of particular interest. A proton-conductive polymer membrane is the main component in this type of fuel cell. Nafion®, which is a perfluorinated polymer with sulfonic acid side groups as produced by Dupont and similar products made by Asahi are still the market-dominating membrane materials for electrolyte membrane fuel cells.

Much research has been done with the aim to use other polymers as membrane materials in fuel cells. These polymers however are almost exclusively sulfonated materials whose proton conductivity is based on sulfonic acid groups.

In a relatively recent publication (M.Yamabe, K. Akijama, Y.Akatsuka, M. Kato, Novel phosphonated perfluorocarbon polymers, Eur. Polym. J. 36(2000) 1034-41), the synthesis of perfluorinated polymers with phosphonic acid side groups based on perfluorovinyloxy-substituted phosphonic acid as monomers is described which are then co-polymerized with tetrafluoroethylene and perfluoropropylvinyl ether. The use of such polymers in fuel cells is disclosed in U.S. Pat. No. A6,087,032.

Additional fuel cell membranes of polymers with phosphoric acid side groups are described for example in U.S. Pat. No. A 5,422,411. These known polymers are made by radical homo- and co-polymerization of α, β, β-trifluorosstyrol-4-phosphoric acid esters and subsequent ester hydrolysis. The product obtained is a polystyrol with perfluorinated main chain, which functionalizes on the phenyl rings with phosphoric acid groups.

Additional polymers for use in fuel cells are described in U.S. Pat. No. A 5,679,482. They are fluorine-free styrol copolymers with a mixed functionalization from sulfonic acid and phosphonic acid groups. The patent describes primarily SEBS-copolymers whose styrol units can be phosphonated by conversion with CICH₂PO(OR)₂. In the product, the phosphonic acid groups are not directly bound to the aromatic rings but by way of a methylene unit.

Also, U.S. Pat. No. -A-4,605,685 deals with the phosphonization of vinyl polymers which are used however for the development of cation exchanger membranes. The phosphonization of polybenzimidazole is described in U.S. Pat. No. -A 5,599,639; here lithium hydride is converted with BrCF₂PO(OR)₂. In the product obtained, the phosphonic acid groups are bound covalently to nitrogen atoms of the imidazole rings by way of CF₂ units.

The first research for the use of phosphonated polymers in fuel cells was published by Cabasso (X. Xu, I. Cabasso, Preliminary study of phosphonate ion exchange membranes for PEM fuel cells, Polym. Mat. Sci. Eng. 68(1993) 120-121). For the manufacture of membranes, a phosphonated polyphenyl oxide and polymer blends prepared therefrom were used. Also in this polymer, whose synthesis is described in U.S. Pat. No. -A-4,073,754, the phosphonic acid groups are separated from the aromatic rings of the polymer main chain by the methylene units. These alkylene spacers reduce the chemical stability of the materials with respect to oxidation means and therefore detrimentally affect the long-term stability of the membranes during operation of a fuel cell.

An essential disadvantage of the initially mentioned perfluorinated materials such as Nafion® is the high price of these materials. With the use of fluorine-free aromatic polymers, it might be possible to lower the material costs without detrimentally affecting the chemical stability. The literature therefore includes numerous examinations directed at the sulfonization of polysulphones, polyether ketones, polyether ether ketones, polyamides and polyphosphazenes. However, all these materials have numerous disadvantages.

It is the object of the present invention to provide a method of producing a polymer for making proton conductive membranes on the basis of a base polymer to provide such a membrane.

### SUMMARY OF THE INVENTION

In a method of producing a polymer for making proton conductive membranes on the basis of a base polymer other than a vinyl polymer said base polymer is

a) bromated or iodized,

b) the bromated or iodized polymer is reacted with at least one of phosphonic acid esters and phosphoric acid esters in the presence of a transition metal catalyst whereby a reaction polymer is formed,

c) the reaction polymer of step b is hydrolyzed, and

d) from the hydrolyzed polymer of step c) a polymer film is produced.

Also, a proton-conductive membrane for electrochemical applications, particularly for use in fuel cells is provided. The membrane consists of a polymer based on a base polymer, other than a vinyl polymer, which includes aromatic rings and also sulfonic acid groups which are bound covalently directly to the aromatic rings of the base polymer, that is, without spacer groups therebetween.

In the method of producing the polymer for a membrane according to the invention, a polymer-based on a base polymer with aromatic rings is utilized which however is not a vinyl polymer. This polymer, which may also be designated an aryl polymer, is phosphonated in such a way that the phosphonic acid groups are bound co-valently directly to the aromatic rings of the base polymer. In other words, there are no spacer groups as it is the case with the conventional phosphonated membranes, or respectively, polymers.

The polymer including phosphonic acid groups preferably includes additional sulfonic acid groups that is, it may be modified thereby.

The base polymer is preferably a polymer from the class of the polysulfanes, the polyethersulfanes, the polyether ketones, the poly ether ether ketones, the polyacrylene oxides, the polyacrylene sulfides, the polyimides, the polybenzimidazoles, the polyoxadiazoles, the polytriazoles and the polyphosphazines.

Methods for the direct phosphonization of aromatic rings are also known but they have been found to be unsuitable in a polymer-analog embodiment. For example, the Friedel-Crafts-reaction with PCl₂ and AlCl₃ is the most simple and least expensive way of direct aromatic phosphonization. It is however known (M. Hartmann, U. Ch. Hipler, H. Carlsohn, Synthese von Styrencopolymeren ungestattigter Phosphonsauren, Acta polymerica 31 (1980) 165-8), that this reaction results at the polymer almost exclusively in cross-linked products because of the trifunctionality of PCl₃.

For the manufacture of the polymer according to the invention and the membrane according to the invention, a three-stage process for the phosphonization has been developed. In this process, the base polymer is in a stage a) bromized or iodized. In stage b), the bromized or iodized polymer is reacted with one or several phosphonic acid esters and/or one or several phosphoric acid esters in the presence of a transition metal catalyst.

The resulting polymer aryl phosphonic acid esters are then hydrolized in a stage c) to form phosphonic acid. The products obtained in this way are soluble in many polar organic solvents but are insoluble in methanol and water. The products can be manufactured from the solution into mechanically and thermally stable films, which can be used as membranes.

It has further been found advantageous to use a solvent in the described conversion.

With the phosphonated polymers, the thermal stability of the fuel cell membranes made therefrom can be improved such that the operating temperature of PEM-fuel cells can be increased.

Below the invention will be described in greater detail on the basis of examples.

### EXAMPLE 1

Bromating of Radel polysulfone

The bromation is performed in accordance with the method described in U.S. Pat. No. - A 4,799,415. The bromium content in the bromated polymer was determined by elementary analysis. The composition of the product corresponded to the sum formula C₂₄H₁₄SO₄Br₂. The substitution degree was 200% (per repetition unit of the polymer).

### EXAMPLE 2

Phosphonating of the dibromated Radel polysulfone (RBr) from example 1.

A solution of 10.0 g RBr in a mixture of 50 ml 1,2 di-chlorobenzene, 20 ml Diethyl phosphite and 5 ml triethylamin were trickled under a protective argon atmosphere into a 90° C. heated solution of 0.3 g Pd(PPh₃)₄ in a mixture of 50 ml 1,2dichlorobenzene, 20 ml diethylphosphite and 5 ml triethylamine. The reaction mixture was then heated to 130° C. for 96 hours in the dark. During this period, further 0.3 g Pd(PPh₃)₄, 40 ml diethyl phosphite and 10 ml triethylamine were successively added. After 96 hours, the polymer was precipitated in methanol was then mixed into chloroform and then again precipitated in methanol. After drying in a vacuum, 8.0 g of the product was obtained. The content of phosphonic acid ester groups was determined by ¹H-NMR-spectroscopy and elementary analysis. Repeatedly a substitution degree of 58% per repitition unit of the polymer was obtained.

### EXAMPLE 3

Phosphonating of the dibromated polysulfone (RBr from example 1).

The reaction preparation of example 2 was repeated. Instead of the Pd(PPh₃)₄, 0.3 g Pd₂(dba)₃CHCl₃ (dba=dibenzylide acetone) was used as catalyst.

The reaction mixture was heated for 96 hour to 120° C.

During this period additional 0.2 g catalyst, 70 ml diethylphosphit and 10 ml triethylamine were successively added. 8.5 g product was obtained. By ¹H-NMR spectroscopy and elementary analysis, it was deteremined that the substitution degree of phosphonic acid ester groups in the product was 77% per repetition unit of the polymer.

### EXAMPLE 4

Phosphoniting of the dibromated Radel Polysulfonic (RBr) from example 1.

A solution of 10.0 g RBR and 0.3 g PD₂(dba)₃CHCl₃ in a mixture of 30 ml diphenylether, 60 diethyl phosphit and 5 ml triethylamine were heated under an argon atmosphere first for 1 hour to 90° C. and then for 96 hour to 120° C. During this period further 0.2 g catalyst, 40 ml diethylphosphate nd 15 ml triethylamine were successively added. After 96 hours, the polymer was precipitated in methanol. After drying under vacuum, 9.5 g product was obtained. The content of phosphonic acid groups was determined by ¹H-NMR spectroscopy and elementary analysis. A substitution degree of 88% per repetition unit of the polymer was determined.

### EXAMPLE 5

Hydrolysis of the polymer phosphonic acid ester of the examples 2-4.

The phosphonated RBr of the examples 2-4 was suspended in 48% bromine hydrogen acid and heated for 24 hours with condensate return. Subsequently, the polymer was filtered out and thoroughly washed with water. By ¹H-NMR spectroscopy no intact phosphonic acid ester groups could be detected in the product. In the hydrolyzed product of example 4, the content of free phosphonic acids corresponded to an ion exchanger capacity of 1.6 mmol/g. After addition of 5% concentrated hydrochloric acid, the dried products were easily soluble in dimethylacetamide. From this solution, mechanically and thermally stable polymer films could easily be prepared.

What is claimed is:

1. A method of producing a polymer for making proton conductive membranes on the basis of a base polymer other than a vinyl polymer comprising the steps of:
a) bromating or iodizing said base polymer,
b) reacting the bromated or iodized polymer with at least one of phosphonic acid esters and phosphoric acid esters in the presence of a transition metal catalyst whereby a reaction polymer is formed,
c) hydrolyzing the reaction polymer of step b, and
d) producing from the hydrolyzed polymer of step c) a polymer film.

2. A method according to claim 1, wherein the steps a), b) and c) are performed in a solvent.

3. A polymer on the basis of a base polymer, other than a vinyl polymer, including aromatic rings, said polymer including phosphonic acid groups which are bound covalently and directly to the aromatic rings without intermediate spacer groups.

4. A polymer according to claim 3, wherein said base polymer is a polymer from the class of polysulfanes and groups bound to said polymer, and is obtainable by the steps of at least one of the claims 4 and 5.
